(19) United States
(12) Patent Application Publication
(10) Pub. No.: US 2013/0210271 A1
(43) Pub. Date: Aug. 15, 2013

(54) COMBINED STACKED CONNECTOR ASSEMBLY

(71) Applicant: Nai-Chien CHANG, New Taipei City (TW)

(72) Inventor: Nai-Chien CHANG, New Taipei City (TW)

(21) Appl. No.: 13/370,648

(22) Filed: Feb. 10, 2012

(51) Int. Cl. H01R 13/74

(52) U.S. Cl. 439/535

(57) ABSTRACT

A combined stacked connector assembly is electrically connected to a printed circuit board and includes an H-shaped insulation support, a first connector module and a second connector module. The H-shaped insulation support has a first accommodating space and a second accommodating space vertically arranged with each other. The first connector module is detachably disposed in the first accommodating space and the second connector module is detachably disposed in the second accommodating space. By this arrangement, various connectors can be combined and stacked to form different kinds of stacked connector assembly, thereby reducing the expense of molds and the production cost.

### BACKGROUND OF THE INVENTION

1. Field of the Invention

The present invention relates to a connector structure, and in particular to a combined stacked connector assembly.

2. Description of Prior Art

With the advancement of science and technology, various connectors are developed, such as RJ45 connector, USB connector, HDMI connector, eSATA connector, axial cable connector, wireless connector or the like. When these different kinds of connectors are mounted in an electronic device, these connectors have to be electrically connected to a printed circuit board. By this arrangement, these connectors can get necessary electricity and electrical signals from the printed circuit board to operate normally.

In order to reduce the occupied area of the connectors on the printed circuit board, the manufacturers in this field propose a stacked connector assembly, in which two, three, four or even five connectors of the same kind or different kinds are stacked up to constitute a connector assembly. However, since there are many kinds of connectors, these kinds of connectors may generate a lot of combinations. As a result, the manufacturers have to produce a lot of kinds of stacked connector assemblies to fit the demands of customers, which inevitably increases the expense of molds and production cost.

On the other hand, after one kind of stacked connector assembly having several connectors is manufactured, it is impossible to replace one of the connectors to become another kind of stacked connector assembly. Thus, the manufactures have to prepare a great number of components because these components cannot be used in common.

Therefore, the present Inventor aims to solve the above problems.

### SUMMARY OF THE INVENTION

The present invention is to provide a combined stacked connector assembly, in which a plurality of connectors can be freely combined and stacked to thereby reduce the expense of molds and production cost.

The present invention provides a combined stacked connector assembly, electrically connected to a printed circuit board and including:
an H-shaped insulation support having a first accommodating space and a second accommodating space vertically arranged with each other;
a first connector module detachably disposed in the first accommodating space and electrically connected to the printed circuit board; and
a second connector module detachably disposed in the second accommodating space and electrically connected to the printed circuit board.

In comparison with the prior art, the present invention has the following advantageous features.

According to the present invention, an H-shaped insulation support is provided, in which a first accommodating space and a second accommodating space located below the first accommodating space are formed. The first connector module is detachably disposed in the first accommodating space, and the second accommodating space is disposed in the second accommodating space. Thus, the manufacturers can produce the first connector module and the second connector module respectively based on the demands of a customer. Then, the first connector module and the second connector module are detachably assembled in the H-shaped insulation support to form the combined stacked connector assembly of the present invention. Therefore, the manufacturer can freely use various connectors to generate a customized stacked connector assembly, thereby reducing the expense of molds and production cost.

On the other hand, since the first connector module and the second connector module are detachably disposed in the first accommodating space and the second accommodating space respectively, the manufacturer can modify one kind of stacked connector assembly to another kind of stacked connector assembly and still use the housing, the H-shaped insulation support and a portion of the connectors of the original stacked connector assembly. Thus, some components can be used in common, so that the number of waste components is reduced.

### BRIEF DESCRIPTION OF DRAWING

FIG. 1 is a perspective view showing the external appearance according to a first embodiment of the present invention;

FIG. 2 is an exploded perspective view showing the first embodiment of the present invention;

FIG. 3 is an assembled perspective view showing the first embodiment of the present invention;

FIG. 4 is an assembled front view showing the first embodiment of the present invention;

FIG. 5 is an assembled cross-sectional view showing the first embodiment of the present invention;

FIG. 6 is an assembled front view showing the first embodiment of the present invention, in which a housing is provided;

FIG. 7A is an assembled perspective view showing a second embodiment of the present invention;

FIG. 7B is an assembled front view showing the second embodiment of the present invention;

FIG. 8A is an assembled perspective view showing a third embodiment of the present invention;

FIG. 8B is an assembled front view showing the second embodiment of the present invention;

FIG. 9 is an exploded perspective view showing a fourth embodiment of the present invention;

FIG. 10A is an assembled perspective view showing a fourth embodiment of the present invention;

FIG. 10B is an assembled front view showing the fourth embodiment of the present invention;

FIG. 11A is an assembled perspective view showing a fifth embodiment of the present invention;

FIG. 11B is an assembled front view showing the fifth embodiment of the present invention;

FIG. 12A is an assembled perspective view showing a sixth embodiment of the present invention;

FIG. 12B is an assembled front view showing the sixth embodiment of the present invention;

FIG. 13 is an exploded perspective view showing a seventh embodiment of the present invention;

FIG. 14A is an assembled perspective view showing the seventh embodiment of the present invention;

FIG. 14B is an assembled front view showing the seventh embodiment of the present invention;

FIG. 15A is an assembled perspective view showing an eighth embodiment of the present invention;

FIG. 15B is an assembled front view showing the eighth embodiment of the present invention;

FIG. 16A is an assembled perspective view showing a ninth embodiment of the present invention;

FIG. 16B is an assembled front view showing the ninth embodiment of the present invention;

FIG. 17 is an assembled cross-sectional view showing a tenth embodiment of the present invention;

FIG. 18 is an assembled front view showing an eleventh embodiment of the present invention;

FIG. 19 is an assembled front view showing a twelfth embodiment of the present invention; and

FIG. 20 is an assembled front view showing a thirteen embodiment of the present invention.

### DETAILED DESCRIPTION OF THE INVENTION

The detailed description and technical contents of the present invention will become apparent with the following detailed description accompanied with related drawings. It is noteworthy to point out that the drawings is provided for the illustration purpose only, but not intended for limiting the scope of the present invention.

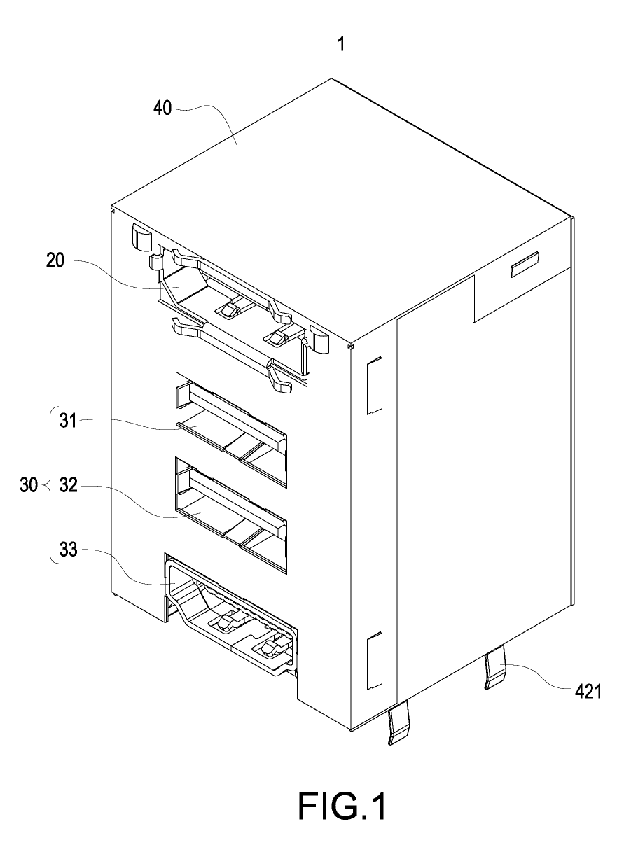

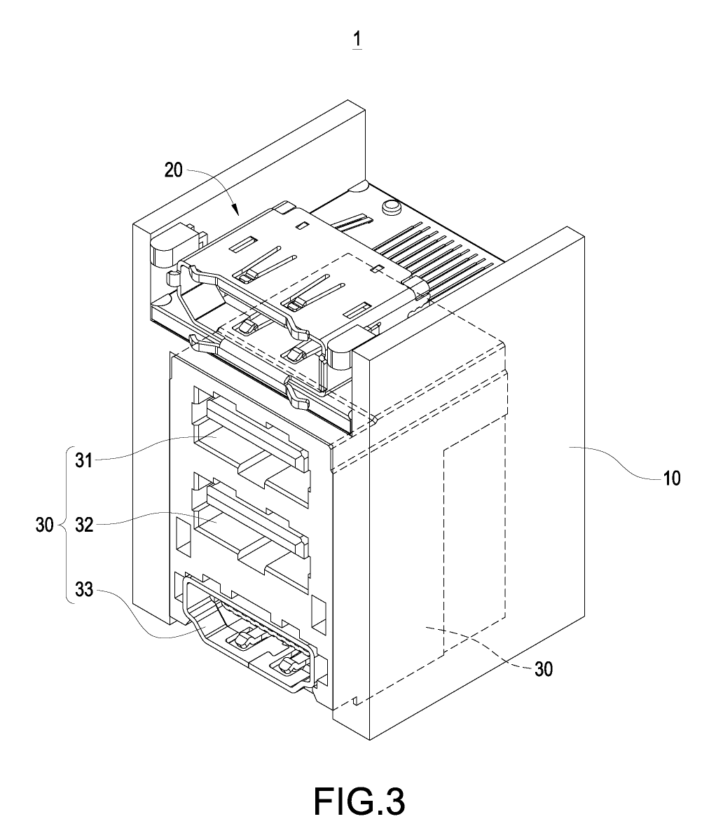

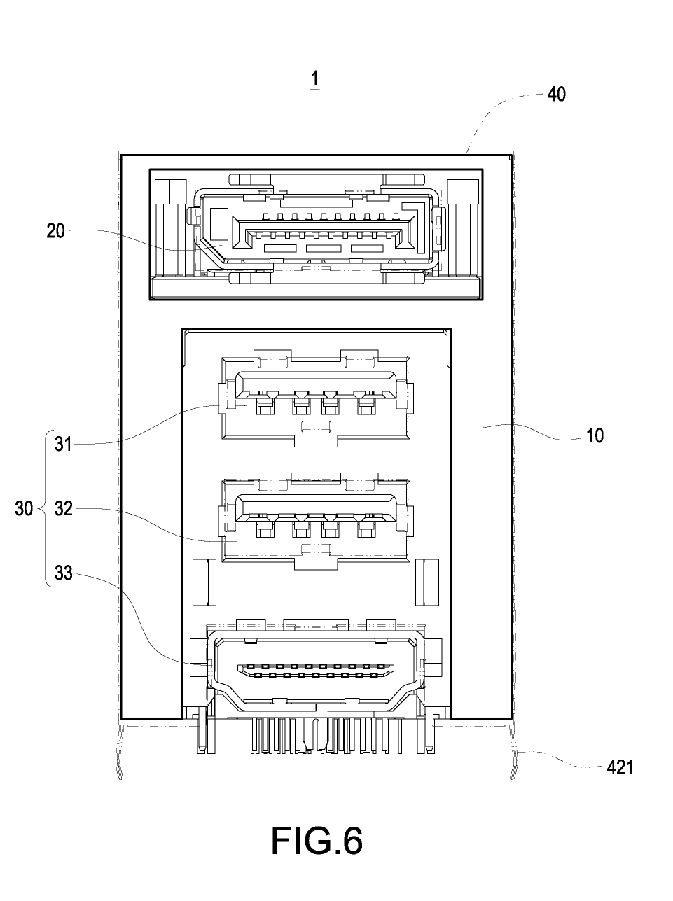

Please refer to FIGS. 1 to 6. The present invention provides a combined stacked connector assembly 1 electrically connected to a printed circuit board. Although not shown in the drawings, such a printed circuit board is apparent for those skilled in this art.

The combined stacked connector assembly 1 of the present invention includes an H-shaped insulation support 10, a first connector module 20, a second connector module 30, and a housing 40.

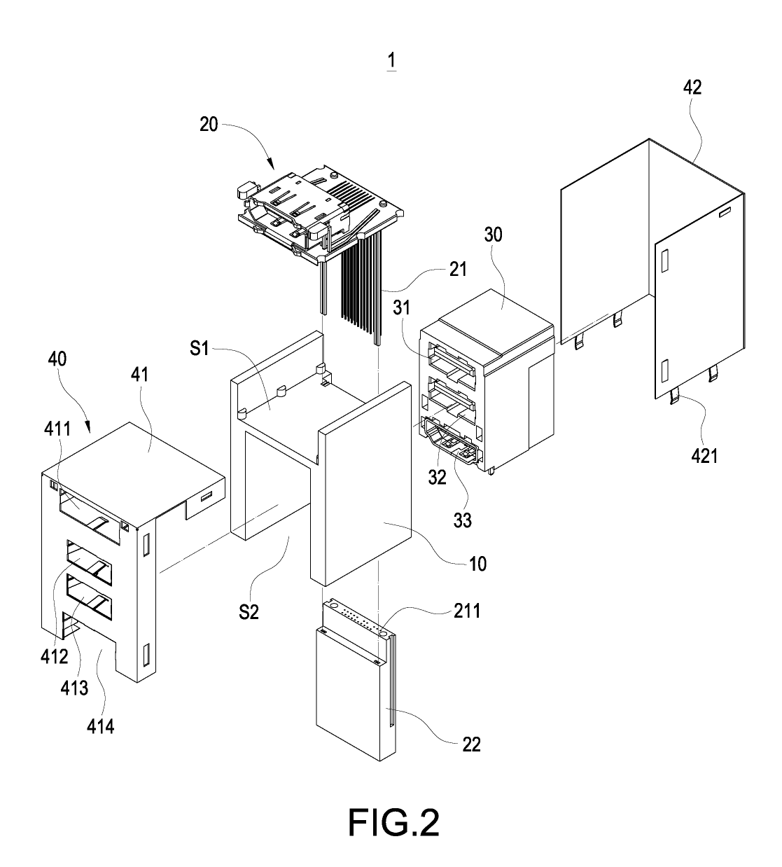

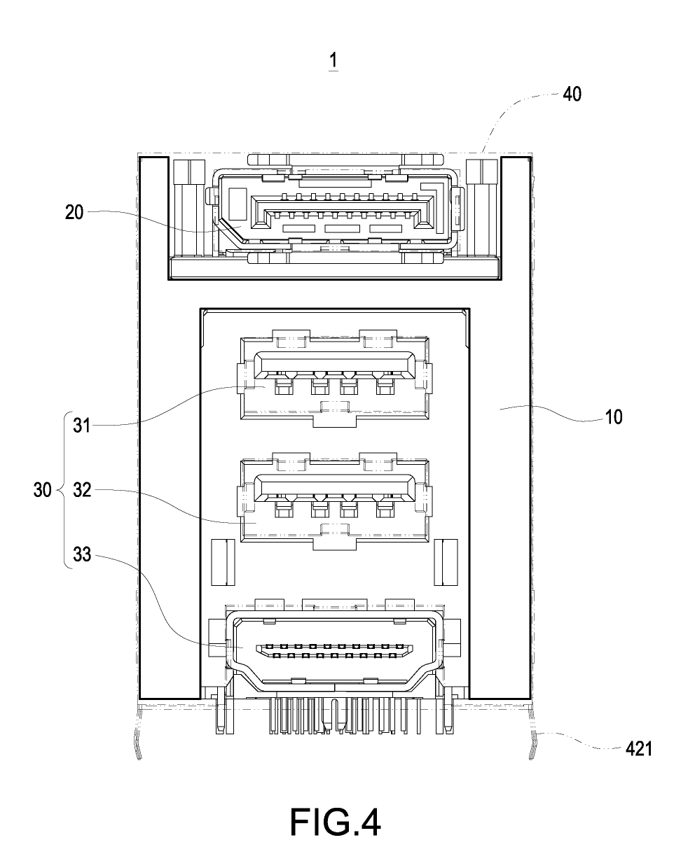

As shown in FIG. 2, the present invention is characterized in the H-shaped insulation support 10 having a first accommodating space S1 and a second accommodating space S2 vertically arranged with each other. It can be clearly seen from FIG. 4 that, the first accommodating space S1 is located above the second accommodating space S2. The width of the first accommodating space S1 is larger than that of the second accommodating space S2, so that the first accommodating space S1 is used to accommodate a wider connector (such as a HDMI connector). The height of the first accommodating space S1 is smaller than that of the second accommodating space S2, so that more connectors can be received in the second accommodating space S2 than in the first accommodating space S1. However, if the first accommodating space S1 is located below the second accommodating space S2, the H-shaped insulation support 10 will become a support with a “narrow-top and wide-bottom” as well as “long-top and short-bottom” structure.

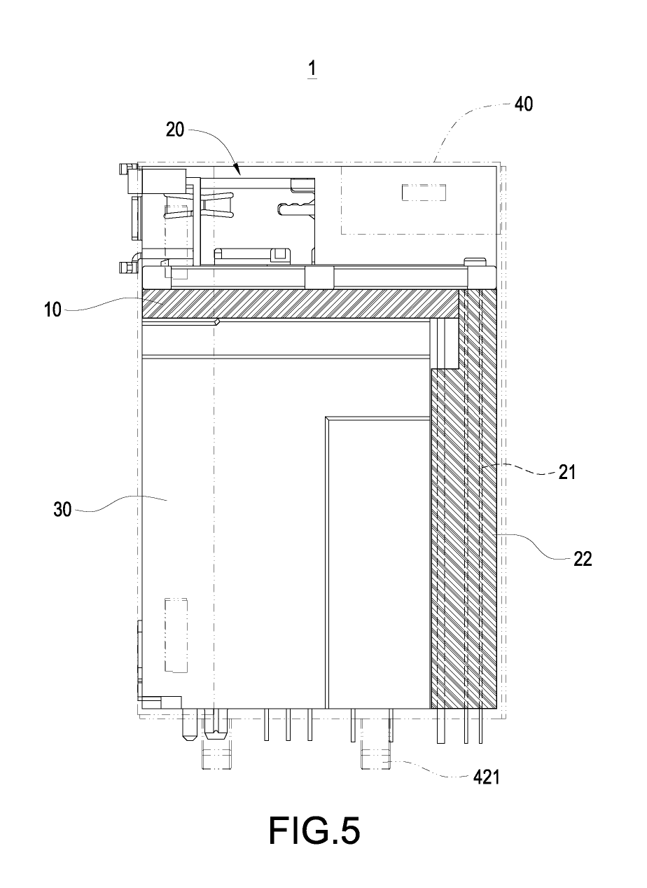

The first connector module 20 is detachably disposed in the first accommodating space S1 and electrically connected to the printed circuit board. In the present embodiment, the first connector module 20 has an HDMI connector. It can be seen from FIG. 5 that, a rear end of the first connector module 20 has a plurality of conductive terminals 21 bent downwardly. These conductive terminals 21 are bent from a rear surface of the H-shaped insulation support 10 to be downwardly inserted into and electrically connected to the printed circuit board. In order to protect these conductive terminals 21, a connecting piece 22 is provided. The connecting piece 22 is provided with a plurality of through-holes 221, so that the conductive terminals 21 of the first connector module 20 can be disposed through the through-holes 221 to be inserted into the printed circuit board.

The second connector module 30 is detachably disposed in the second accommodating space S2 and electrically connected to the printed circuit board. In the present embodiment, the second connector module 30 comprises two overlapped USB connectors 31, 32 and an HDMI connector 33 located below the two overlapped USB connectors 31, 32.

It can be seen from FIG. 2 that, the second connector module 30 comprises three connectors and is a connector module made in advance. In other words, the manufacturer can produce the second connector module 30 first and then put the second connector module 30 in the second accommodating space S2 of the H-shaped insulation support 10. Finally, the first connector module 20 is disposed in the first accommodating space S1 to form the combined stacked connector assembly 1 of the present invention. The manufacturer can freely change the first connector module 20 and the second connector module 30 to produce different kinds of stacked connector assemblies. In the following, the present invention will be described with reference to different embodiments.

The housing 40 is constituted of a front casing 41 and a rear casing 42. The front casing 41 covers a front surface and an upper surface of the H-shaped insulation support 10. The rear casing 42 covers a left surface, a right surface and a rear surface of the H-shaped insulation support 10. The front surface of the front casing 41 is provided with a plurality of openings 411, 412, 413 and 414 at positions corresponding to those of the first connector module 20 and the respective connectors 31, 32 and 33 of the second connector module 30, so that external plugs can be inserted into the corresponding connectors. The front casing 41 and the rear casing 42 can be connected by means of the engagement between hooks and troughs or the engagement between protrusions and troughs. The lower edge of the rear casing 42 is formed with a plurality of fixing legs 421 for fixing the whole combined stacked connector assembly 1 onto the printed circuit board.

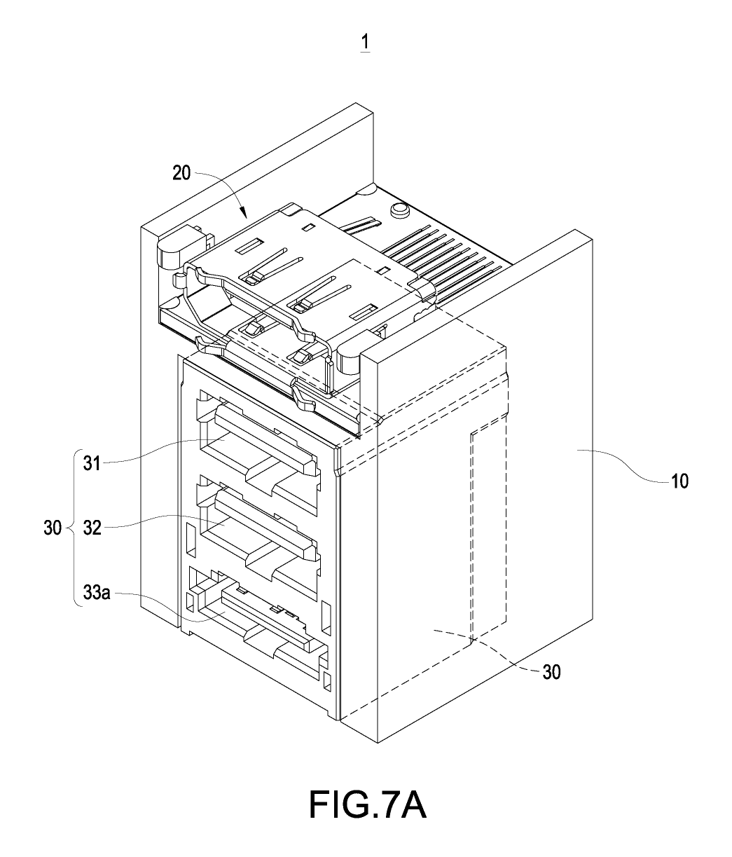

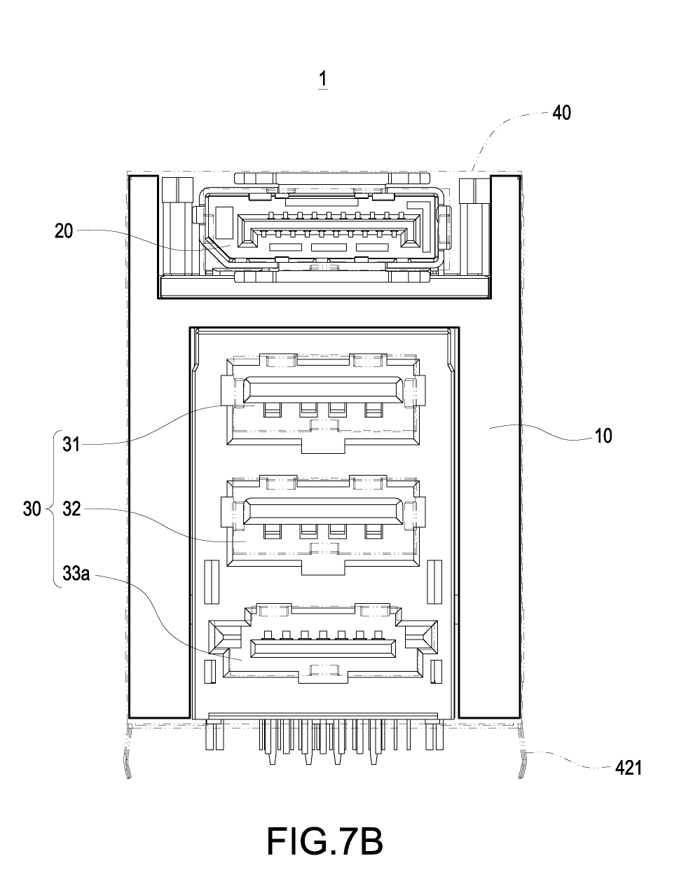

Please refer to FIGS. 7A and 7B, which show the second embodiment of the present invention. The difference between the second embodiment and the previous embodiment lies in that: in the second embodiment, the second connector module 30 comprises two overlapped USB connectors 31, 32 and an eSATA connector 33a located below the two overlapped USB connectors 31, 32.

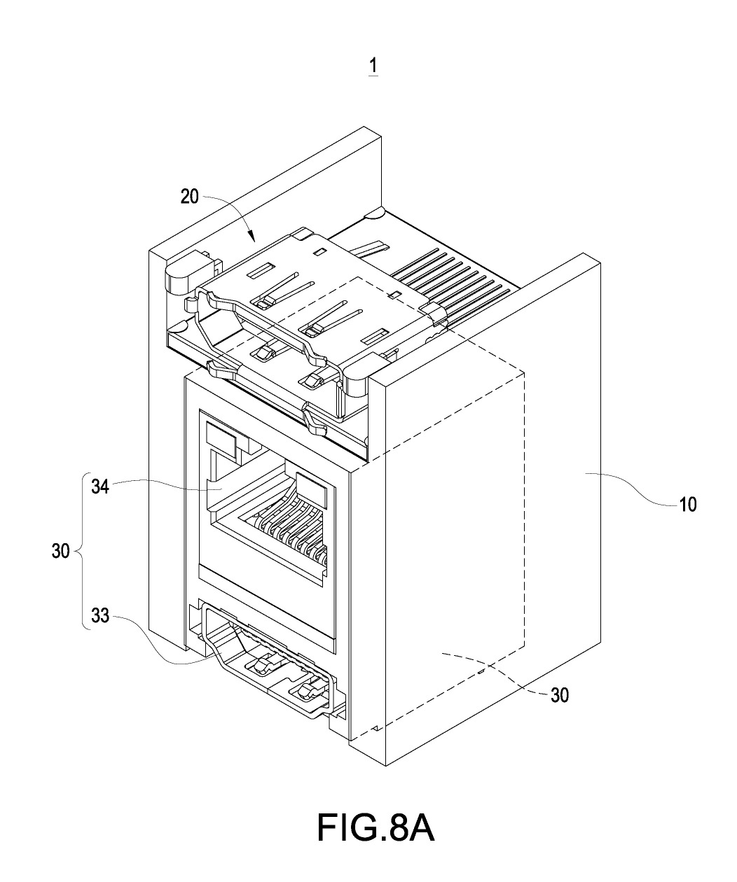

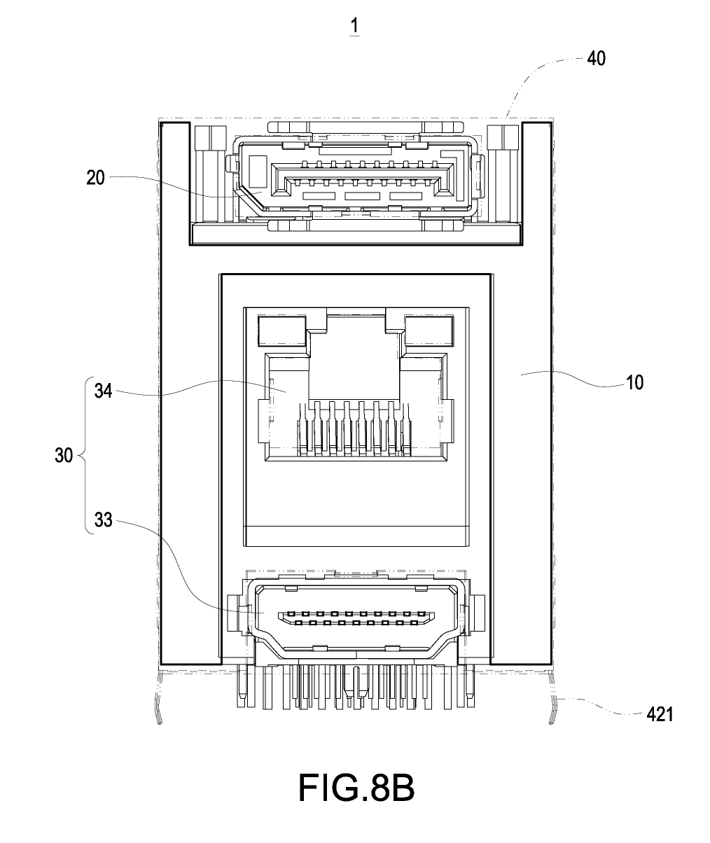

Please refer to FIGS. 8A and 8B, which show the third embodiment of the present invention.

The difference between the third embodiment and the previous embodiments lies in that: in the third embodiment, the second connector module 30 comprises a RJ45 connector 34 and an HDMI connector 33 located below the RJ45 connector 34.

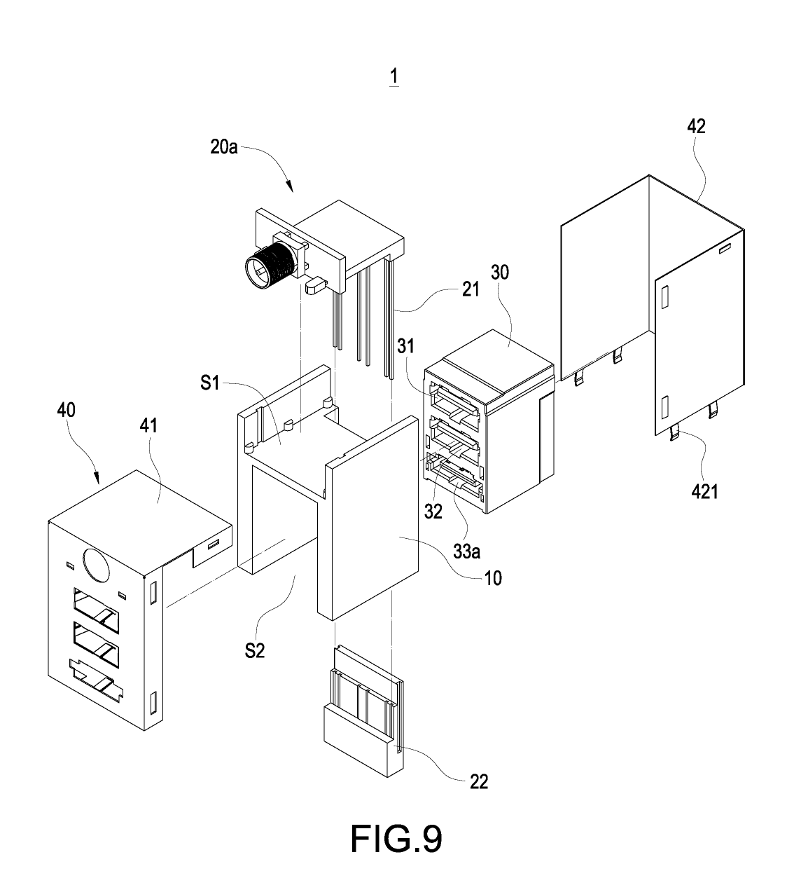

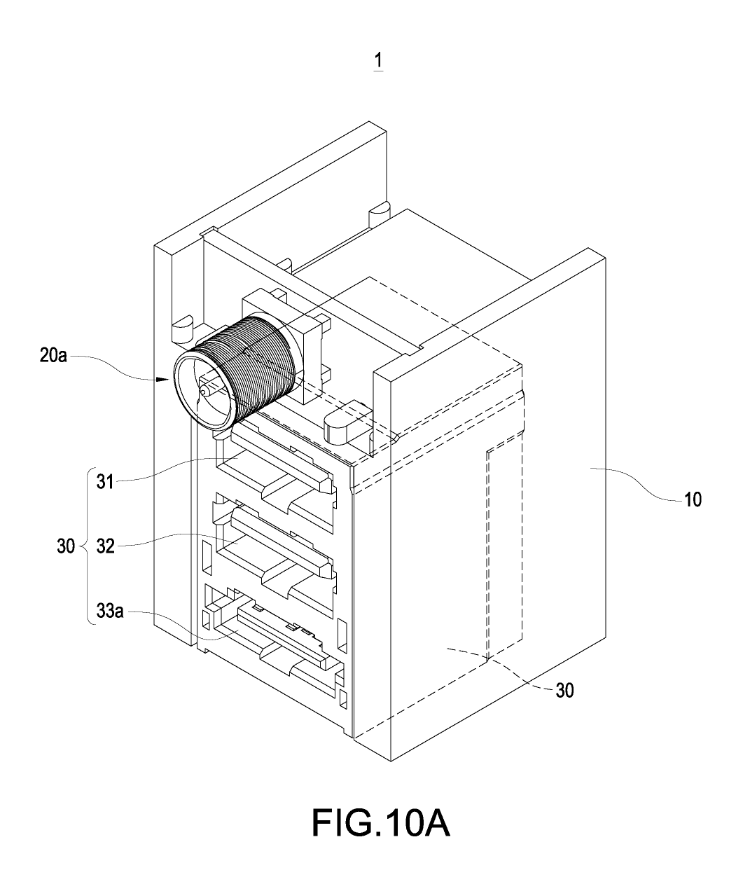

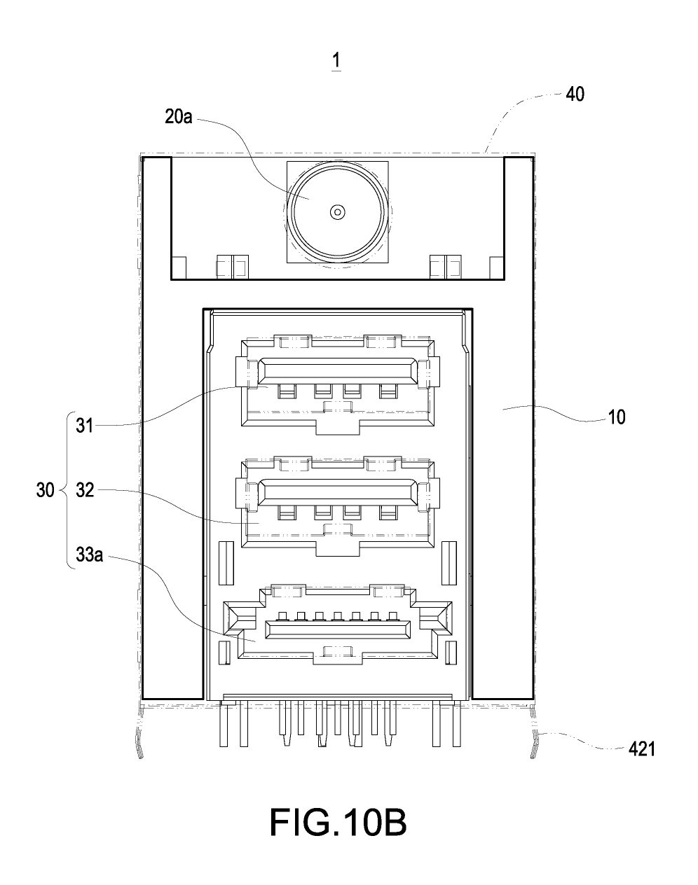

Please refer to FIGS. 9, 10A and 10B, which show the fourth embodiment of the present invention. The difference between the fourth embodiment and the previous embodiments lies in that: in the fourth embodiment, the first connector module 20a is an axial cable connector. The second connector module 30 comprises two overlapped USB connectors 31, 32 and an eSATA connector 33a located below the two overlapped USB connectors 31, 32.

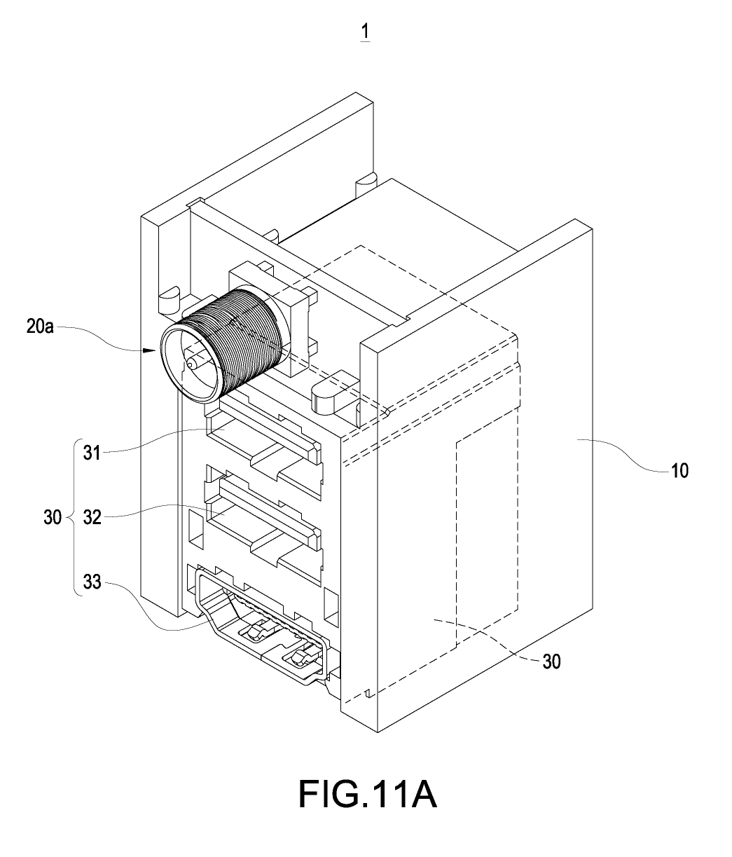

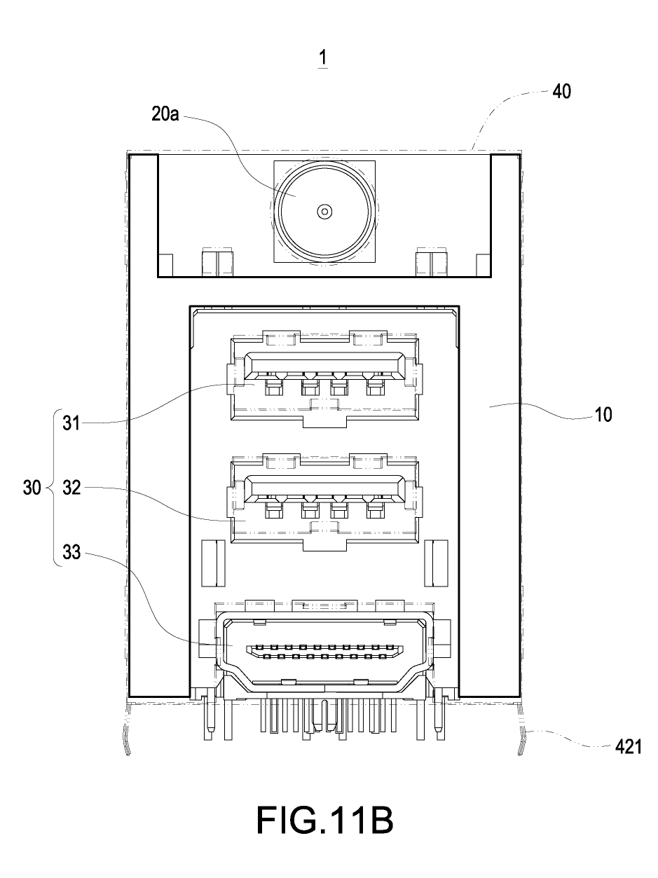

Please refer to FIGS. 11A and 11B, which show the fifth embodiment of the present invention. The difference between the fifth embodiment and the previous embodiments lies in that: in the fifth embodiment, the first connector module 20a is an axial cable connector. The second connector module 30 comprises two overlapped USB connectors 31, 32 and an HDMI connector 33 located below the two overlapped USB connectors 31, 32.

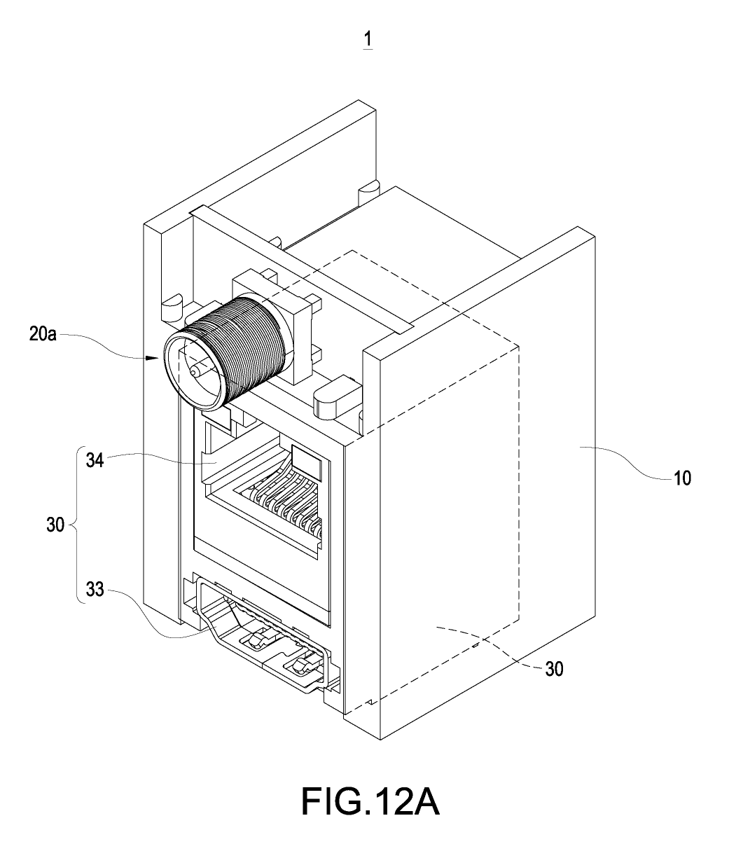

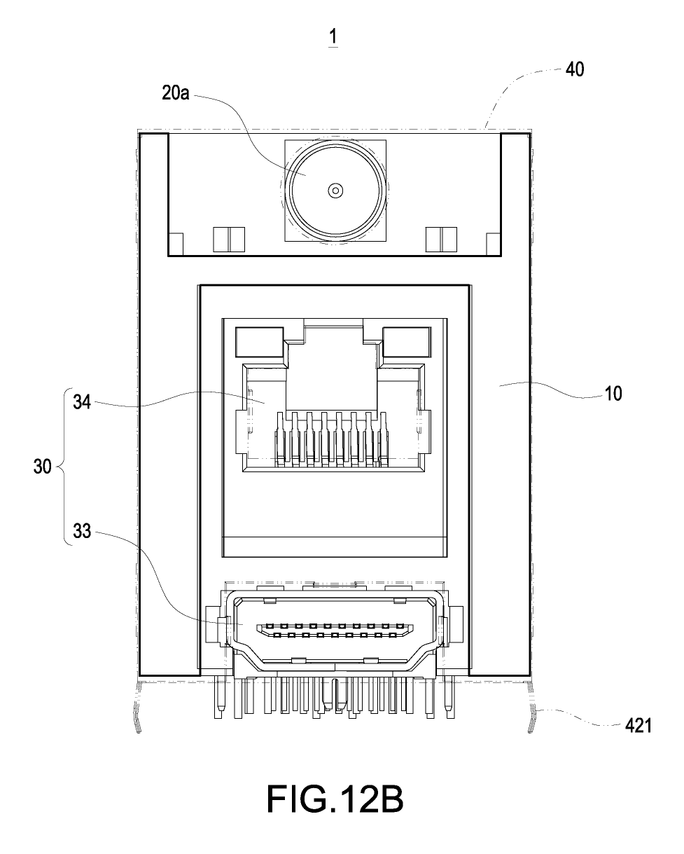

Please refer to FIGS. 12A and 12B, which show the sixth embodiment of the present invention. The difference between the sixth embodiment and the previous embodiments lies in that: in the sixth embodiment, the first connector module 20a is an axial cable connector. The second connector module 30 comprises a RJ45 connector 34 and an HDMI connector 33 located below the RJ45 connector 34.

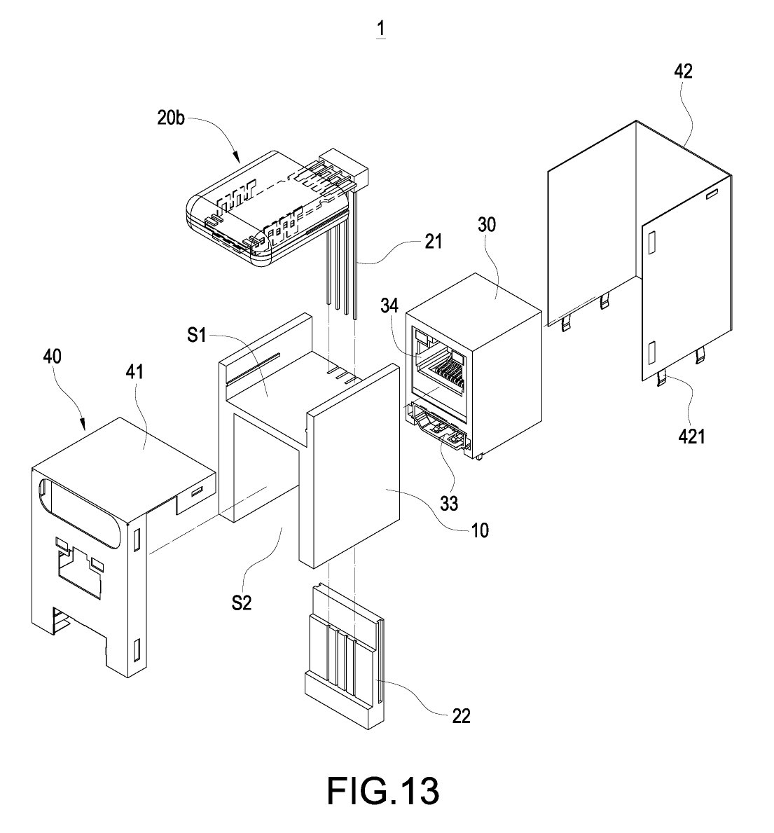

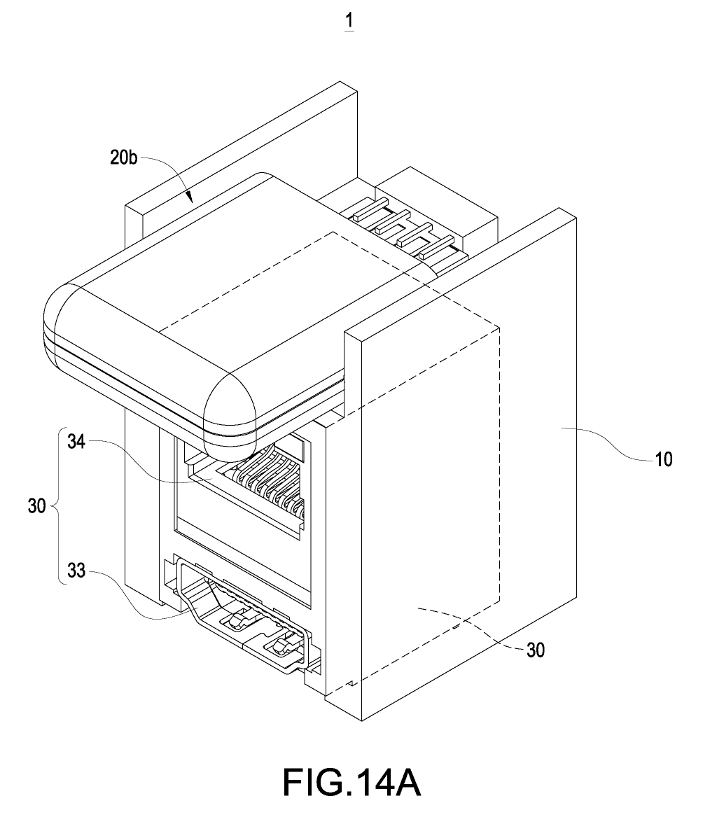

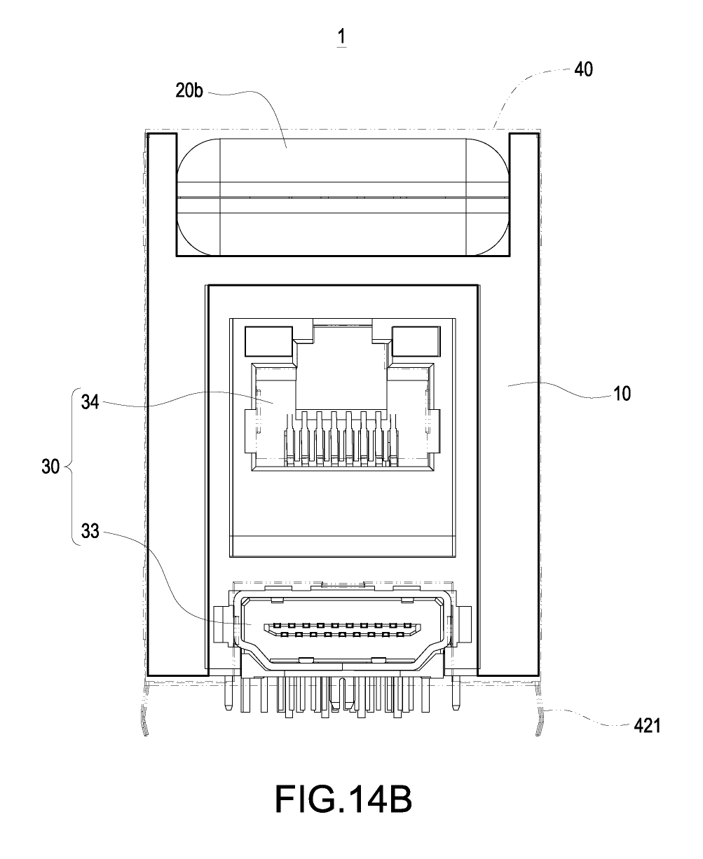

Please refer to FIGS. 13, 14A and 14B, which show the seventh embodiment of the present invention. The difference between the seventh embodiment and the previous embodiments lies in that: in the seventh embodiment, the first connector module 20b is a wireless connector. The second connector module 30 comprises a RJ45 connector 34 and an HDMI connector 33 located below the RJ45 connector 33.

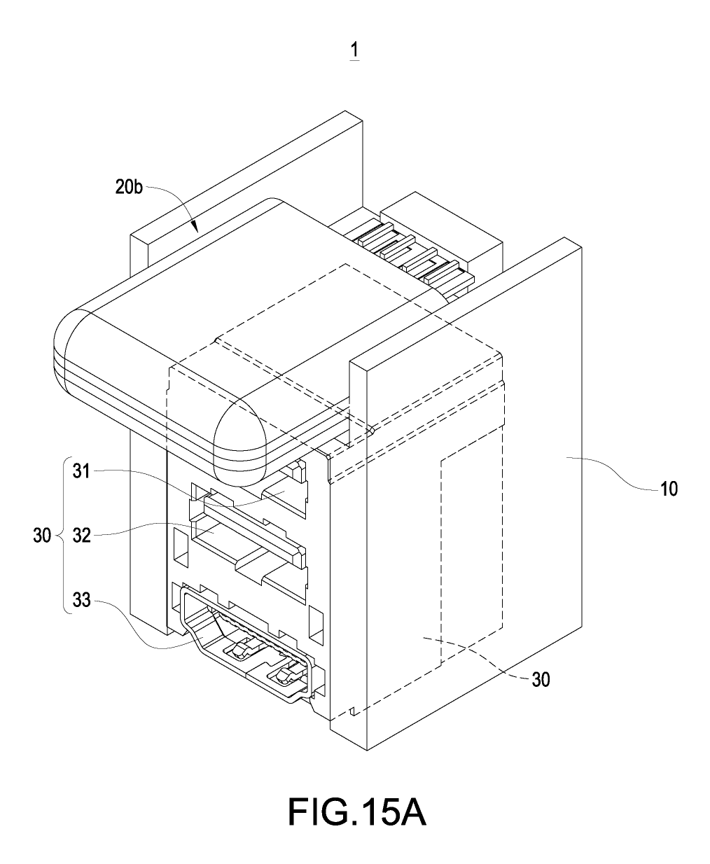

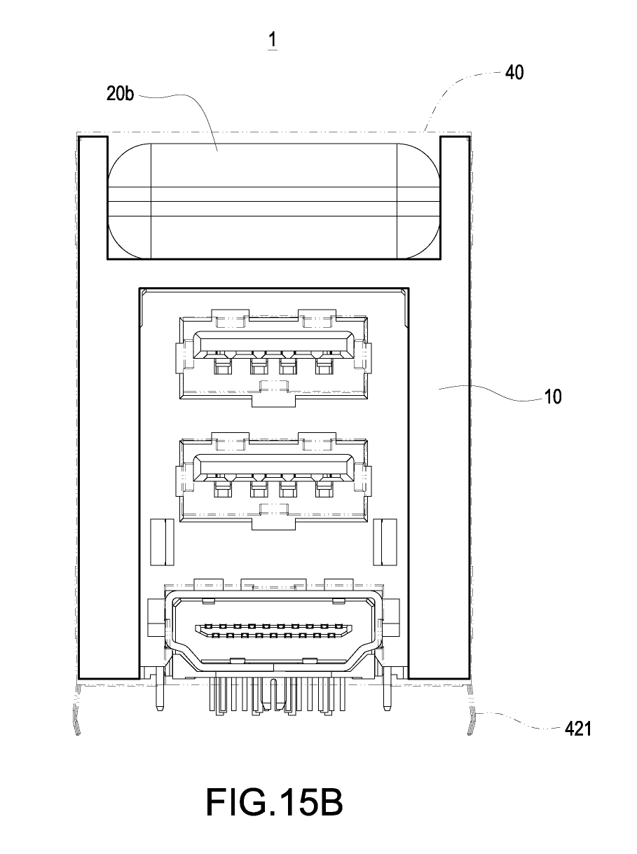

Please refer to FIGS. 15A and 15B, which show the eighth embodiment of the present invention. The difference between the eighth embodiment and the previous embodiments lies in that: in the eighth embodiment, the first connector module 20b is a wireless connector. The second connector module 30 comprises two overlapped USB connectors 31, 32 and an HDMI connector 33 located below the two overlapped USB connectors 31, 32.

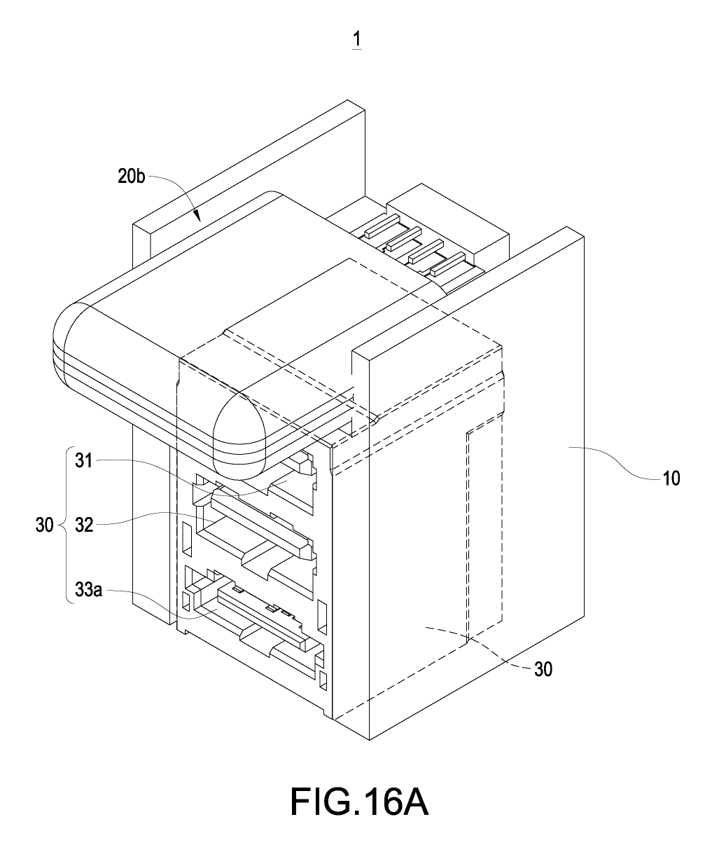

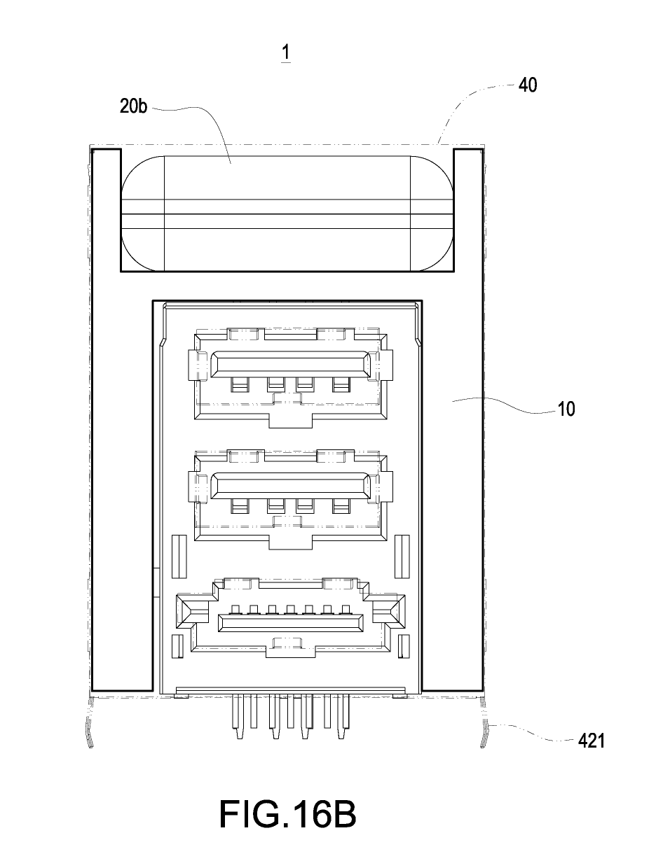

Please refer to FIGS. 16A and 16B, which show the ninth embodiment of the present invention. The difference between the ninth embodiment and the previous embodiments lies in that: in the ninth embodiment, the first connector module 20b is a wireless network receiver. The second connector module 30 comprises two overlapped USB connectors 31, 32 and an eSATA connector 33a located below the two overlapped USB connectors 31, 32.

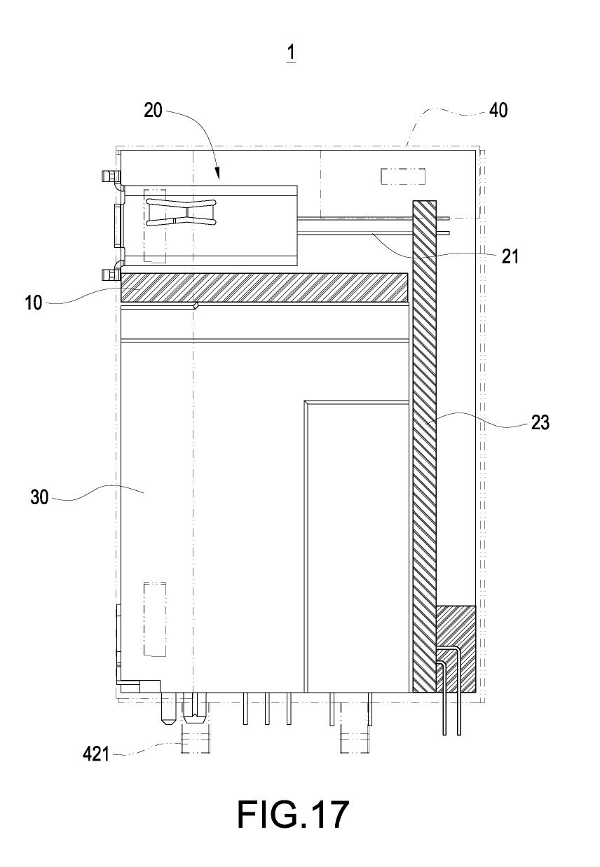

Please refer to FIG. 17, which shows the tenth embodiment of the present invention on the basis of the first embodiment thereof After the conductive terminals 21 of the first connector module 20 are electrically connected to an adapting circuit board 23, the adapting circuit board 23 is inserted onto the printed circuit board.

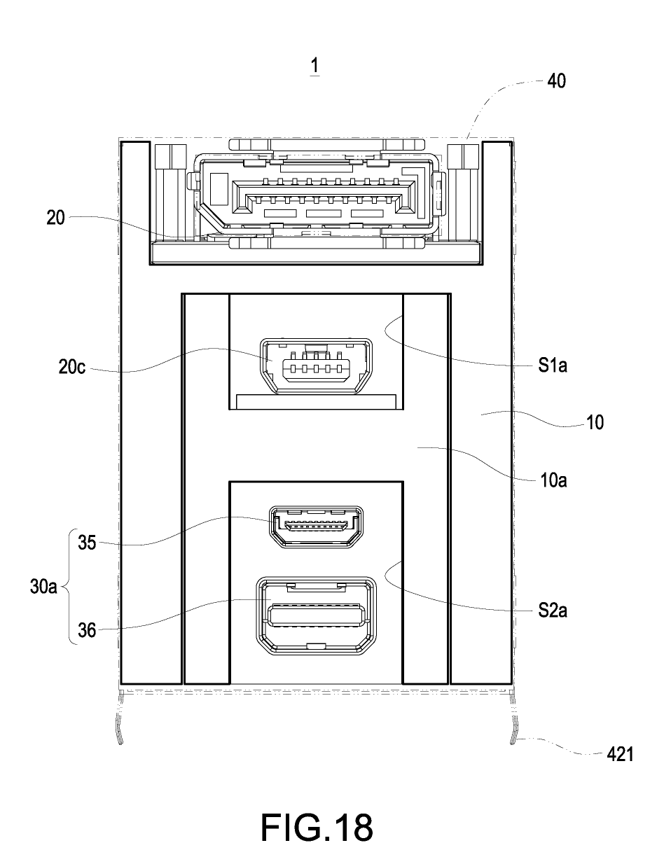

Please refer to FIG. 18, which shows the eleventh embodiment of the present invention. An H-shaped insulation sub-support 10a is disposed in the second accommodating space S2. The H-shaped insulation sub-support 10a also has a first accommodating sub-space S1a and a second accommodating sub-space S2a vertically arranged with each other. A mini-type first connector module 20c and a mini-type second connector module 30a are disposed in the first accommodating sub-space S1a and the second accommodating sub-space S2a respectively. The mini-type first connector module 20c is a mini-USB connector. The second connector module 30a comprises a mini-HDMI connector 35 and a mini Display Port connector 36 overlapped with each other.

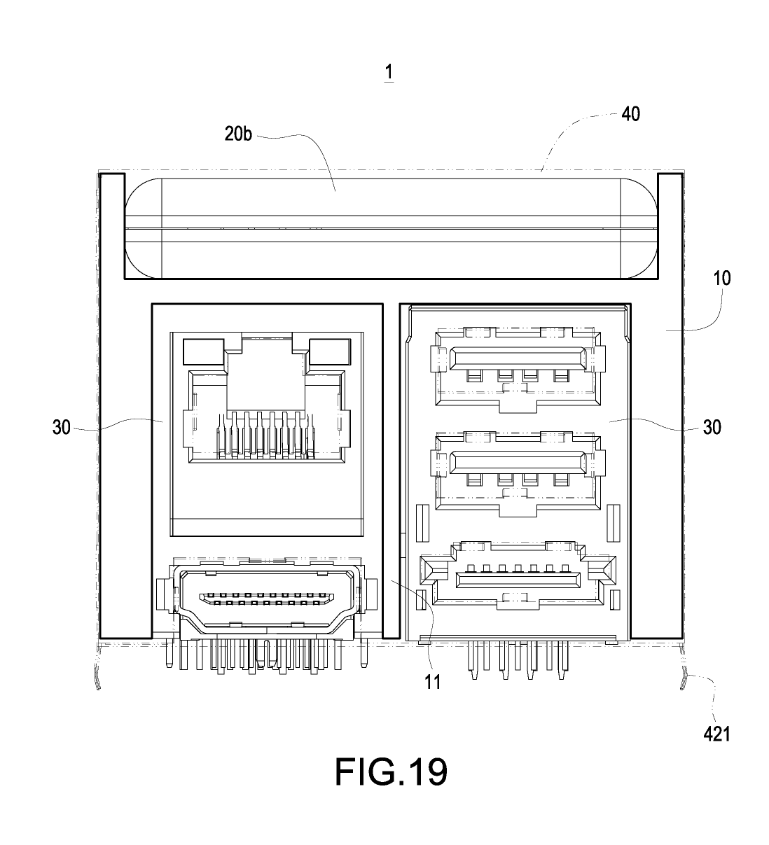

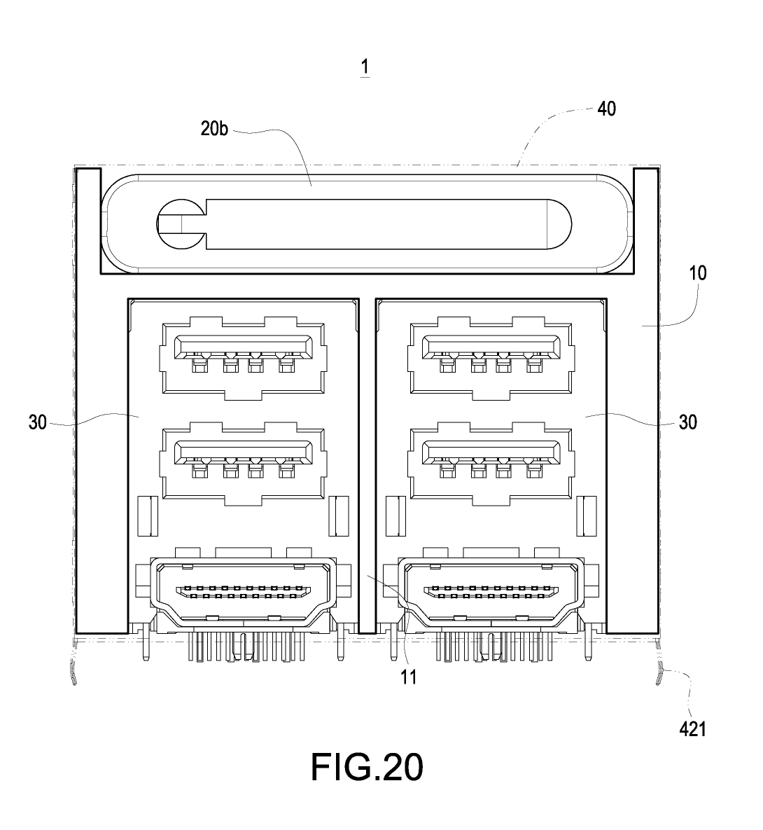

Please refer to FIGS. 19 and 20. The width of the H-shaped insulation support 10 can be increased to widen the first accommodating space S1 and the second accommodating space S2. The first accommodating space S1 is configured to accommodate a wider first connector module 20b, such as a wireless network base station or wireless network router. A partitioning plate is vertically provided in the middle of the second accommodating space S2, so that two second connector modules 30 can be disposed therein to increase the number and kinds of the connectors received therein.

In the previous embodiments, although the first connector module 20 disposed in the first accommodating space S1 comprises one connector, and the second connector module 30 disposed in the second accommodating space S2 comprises three connectors, thereby forming a combined stacked connector assembly 1 having a “one-in-top and three-in-bottom” structure. However, it can be contemplated by those skilled in this art that, the first accommodating space S1 and the second accommodating space S2 can be modified to form various kinds of combined stacked connector assembly having a “one-in-top and four-in-bottom”, “two-in-top and three-in-bottom”, “two-in-top and two-in-bottom”, “three-in-top and one-in-bottom” or “three-in-top and two-in-bottom” structure. The combined stacked connector assembly of the present invention is not limited to have a “one-in-top and three-in-bottom” structure only. Further, each kind of the combined stacked connector assembly 1 can also generate a plurality of combinations by changing the number and kinds of the connectors in the first connector module 20 and the second connector module 30.

In comparison with the prior art, the present invention has the following advantageous features.

According to the present invention, an H-shaped insulation support 10 is provided, in which a first accommodating space S1 and a second accommodating space S2 located below the first accommodating space S1 are formed. The first connector module 20 is detachably disposed in the first accommodating space S1, and the second connector module 30 is detachably disposed in the second accommodating space S2. Thus, the manufacturers can produce the first connector module 20 and the second connector module 30 respectively based on the demands of a customer. Then, the first connector module 20 and the second connector module 30 are detachably assembled in the H-shaped insulation support 10 to form the combined stacked connector assembly 1 of the present invention. Therefore, the manufacturer can freely use various connectors to generate a customized stacked connector assembly, thereby reducing the expense of molds and production cost.

On the other hand, since the first connector module 20 and the second connector module 30 are detachably disposed in the first accommodating space S1 and the second accommodating space S2 respectively, the manufacturer can modify one kind of stacked connector assembly to another kind of stacked connector assembly and still use the housing 40, the H-shaped insulation support 10 and a portion of the connector of the original stacked connector assembly. Thus, some components can be used in common, so that the number of waste components can be reduced.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A combined stacked connector assembly, electrically connected to a printed circuit board and including:
an H-shaped insulation support having a first accommodating space and a second accommodating space vertically arranged with each other;
a first connector module detachably disposed in the first accommodating space and electrically connected to the printed circuit board; and
a second connector module detachably disposed in the second accommodating space and electrically connected to the printed circuit board.

2. The combined stacked connector assembly according to claim 1, further including a housing, the H-shaped insulation support being disposed in the housing.

3. The combined stacked connector assembly according to claim 1, wherein the width of the first accommodating space is larger than the width of the second accommodating space, the height of the first accommodating space is smaller than the height of the second accommodating space.

4. The combined stacked connector assembly according to claim 3, wherein a rear end of the first connector module has a plurality of conductive terminals bent downwardly, the conductive terminals are bent from a rear surface of the H-shaped insulation support to be downwardly inserted into and electrically connected to the printed circuit board.

5. The combined stacked connector assembly according to claim 4, further including a connecting piece provided with a plurality of through-holes, the conductive terminals of the first connector module being disposed through the through-holes to be inserted into the printed circuit board.

6. The combined stacked connector assembly according to claim 3, wherein the first connector module comprises an HDMI connector, the second connector module comprises two overlapped USB connectors and an HDMI connector located below the two overlapped USB connectors.

7. The combined stacked connector assembly according to claim 3, wherein the first connector module comprises an HDMI connector, the second connector module comprises two overlapped USB connectors and an eSATA connector located below the two overlapped USB connectors.

8. The combined stacked connector assembly according to claim 3, wherein the first connector module comprises an HDMI connector, the second connector module comprises a RJ45 connector and an HDMI connector located below the RJ45 connector.

9. The combined stacked connector assembly according to claim 3, wherein the first connector module comprises a coaxial cable connector, the second connector module comprises two overlapped USB connectors and an eSATA connector located below the two overlapped USB connectors.

10. The combined stacked connector assembly according to claim 3, wherein the first connector module comprises a coaxial cable connector, the second connector module comprises two overlapped USB connectors and an HDMI connector located below the two overlapped USB connectors.

11. The combined stacked connector assembly according to claim 3, wherein the first connector module comprises a wireless connector, the second connector module comprises a RJ45 connector and an HDMI connector located below the RJ45 connector.

12. The combined stacked connector assembly according to claim 3, wherein the first connector module comprises a wireless network receiver, the second connector module comprises two overlapped USB connectors and an HDMI connector located below the two overlapped USB connectors.

13. The combined stacked connector assembly according to claim 3, wherein the first connector module comprises a wireless network receiver, the second connector module comprises two overlapped USB connectors and an eSATA connector located below the two overlapped USB connectors.

14. The combined stacked connector assembly according to claim 3, wherein a rear end of the first connector module has a plurality of conductive terminals electrically connected to an adapting circuit board, and then the adapting circuit board is inserted into the printed circuit board.

15. The combined stacked connector assembly according to claim 3, wherein the first connector module comprises a wireless network base station, the second accommodating space is vertically provided with a partition plate, so that two second connector modules can be disposed in the second accommodating space.

16. The combined stacked connector assembly according to claim 3, wherein the first connector module comprises a wireless network router, the second accommodating space is vertically provided with a partition plate, so that two second connector modules can be disposed in the second accommodating space.

17. The combined stacked connector assembly according to claim 3, wherein the second accommodating space is further provided with an H-shaped insulation sub-support, the H-shaped insulation sub-support has a first accommodating sub-space and a second accommodating sub-space vertically arranged with each other, the second connector module comprises mini-type connectors disposed in the first and second accommodating sub-spaces respectively.

18. The combined stacked connector assembly according to claim 17, wherein the first accommodating sub-space is also provided with a mini-type connector.

19. The combined stacked connector assembly according to claim 17, wherein the first accommodating sub-space is provided with a mini-USB connector, the second connector module comprises a mini-HDMI connector and a mini Display Port connector.

20. The combined stacked connector assembly according to claim 2, wherein the housing includes a front casing and a rear casing, the front casing covers a front surface and an upper surface of the H-shaped insulation support, the rear casing covers a left surface, a right surface and a rear surface of the H-shaped insulation support, the front surface of the front casing is provided with a plurality of openings at positions corresponding to those of the connectors of the first connector module and the second connector module, an lower edge of the rear casing is formed with a plurality of fixing legs for fixing the whole combined stacked connector assembly onto the printed circuit board.
